(19) United States
(12) Patent Application Publication
(10) Pub. No.: US 2017/0318515 A1
(43) Pub. Date: Nov. 2, 2017

(54) Mobile-Side Trigger Techniques for Cellular Handover

(71) Applicant: Apple Inc., Cupertino, CA (US)

(72) Inventors: Sunny Arora, San Jose, CA (US); Anil G. Naik, San Jose, CA (US)

(21) Appl. No.: 15/142,340

(22) Filed: Apr. 29, 2016

(51) Int. Cl. H04W 36/24; H04W 36/00; H04W 36/04; H04W 36/36

(52) U.S. Cl. CPC H04W 36/24; H04W 36/36; H04W 36/0083; H04W 36/04

(57) ABSTRACT

Embodiments are presented herein of techniques for a mobile device to control timing of inter-RAT handovers. In some embodiments, an apparatus includes one or more processing elements configured to execute an interactive wireless communication application using a wireless communication configuration between the apparatus and a communications network for a first RAT. In some embodiments, the wireless communication configuration does not have a QoS guarantee. In some embodiments, the apparatus is configured to store information from the communications network that specifies one or more wireless thresholds relating to handover from the first RAT to a second RAT. In some embodiments, based on executing the application and current wireless conditions, the apparatus is configured to send a report to a base station of the communications network, prior to at least one of the thresholds being met, to trigger a handover from the first RAT to the second RAT.

### FIELD

The present application relates to wireless communications, and more particularly to techniques for mobile-side control of timing for inter-RAT handovers.

### DESCRIPTION OF THE RELATED ART

Wireless communication systems are rapidly growing in usage. Additionally, there exist numerous different wireless communication technologies and standards. Some examples of wireless communication technologies include GSM, UMTS (associated with, for example, WCDMA or TD-SCDMA air interfaces), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), IEEE 802.16 (WiMAX), Bluetooth, and others.

Wireless technologies are increasingly using packet-switched connections for performing voice and video communication between users, e.g., using VoLTE (Voice over LTE (Long Term Evolution)) or video over LTE. Past technologies typically utilized circuit-switched networks for voice communications and packet-switched networks for data.

Typically, the network (e.g., the base station) determines thresholds for when to switch a mobile device from operating on one cell to another cell or from one radio access technology (RAT) to another RAT. In some situations, however, e.g., when a voice over internet protocol (VoIP) call is ongoing, waiting for the network-specified thresholds may result in call drops or poor audio quality. This is especially true near a cell edge, e.g., when switching from RAT such as LTE to another such as UMTS. While voice over LTE (VoLTE) calls may use a dedicated bearer that provides a certain quality of service (QoS) and a guaranteed bit rate (GBR), other real-time applications such as certain voice calls, video communications, etc. may use a default bearer without such performance.

### SUMMARY

Embodiments are presented herein of techniques for a mobile device to control timing of inter-RAT handovers. In some embodiments, an apparatus (e.g., a mobile device) includes one or more processing elements configured to execute an interactive wireless communication application using a wireless communication configuration (e.g., a bearer) between the apparatus and a communications network for a first radio access technology (RAT). In some embodiments, the wireless communication configuration does not have a quality of service (QoS) guarantee (or a guaranteed bit rate, for example, or otherwise does not ensure that constraints of the interactive application are met). In some embodiments, the apparatus is configured to store information from the communications network that specifies one or more wireless thresholds relating to handover from the first RAT to a second RAT. In some embodiments, based on executing the application and current wireless conditions, the apparatus is configured to send a report to a base station of the communications network, prior to at least one of the thresholds being met, to trigger a handover from the first RAT to the second RAT. In some embodiments, this may improve call quality at a cell edge of the first RAT, for example.

In some embodiments the first RAT is a an LTE RAT and the second RAT is another RAT. In some embodiments, the apparatus is configured to trigger the measurement report prior to a serving cell of the first RAT deteriorating below a threshold level and/or prior to a target cell of the second RAT improving above a threshold level. The interactive wireless communication application may be a voice application or a video application, for example.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings, in which:

FIG. 1 illustrates an exemplary (and simplified) wireless communication system, according to some embodiments;

FIG. 2 illustrates a base station (BS) in communication with a user equipment (UE) device, according to some embodiments;

FIG. 3 illustrates an exemplary block diagram of a UE, according to some embodiments;

FIG. 4 illustrates an exemplary block diagram of a BS, according to some embodiments; and

FIGS. 5A-5D illustrate exemplary signal conditions on different RATs relative to various thresholds, according to some embodiments.

FIG. 6 is a flow diagram illustrating an exemplary method performed by a mobile device to trigger inter-RAT handover, according to some embodiments.

FIG. 7 is a flow diagram illustrating a more generalized exemplary method for triggering inter-RAT handover, according to some embodiments.

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “clock circuit configured to generate an output clock signal” is intended to cover, for example, a circuit that performs this function during operation, even if the circuit in question is not currently being used (e.g., power is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function. After appropriate programming, the FPGA may then be configured to perform that function.

Reciting in the appended claims that a structure is “configured to” perform one or more tasks is expressly intended not to invoke 35 U.S.C. §112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

### DETAILED DESCRIPTION

### Acronyms

The following acronyms may be used in the present disclosure.

3GPP: Third Generation Partnership Project

3GPP2: Third Generation Partnership Project 2

APN: Access Point Name

BLER: Block Error Rate (same as Packet Error Rate)

BER: Bit Error Rate

CRC: Cyclic Redundancy Check

DL: Downlink

GBR: Guaranteed Bit Rate

GSM: Global System for Mobile Communications

IMS: IP Multimedia Subsystem

IP: Internet Protocol

LTE: Long Term Evolution

MME: Mobility Management Entity

MO: Message Originating

MT: Message Terminating

NAS: Non-access Stratum

PCC: Policy and Charging Control

PCEF: Policy and Charging Enforcement Function

PCRF: Policy and Charging Rules Function

PCSCF: Proxy Call Session Control Function

PGW: Packet Gateway

PER: Packet Error Rate

QCI: Quality of Service Class Index

QoS: Quality of Service

RAT: Radio Access Technology

RRC: Radio Resource Control

SGW: Serving Gateway

SINR: Signal to Interference-and-Noise Ratio

SIR: Signal to Interference Ratio

SNR: Signal to Noise Ratio

Tx: Transmission

UE: User Equipment

UL: Uplink

UMTS: Universal Mobile Telecommunication System

VoLTE: Voice Over LTE

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., a smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless cellular telephone system or cellular radio system.

Processing Element—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually,” where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

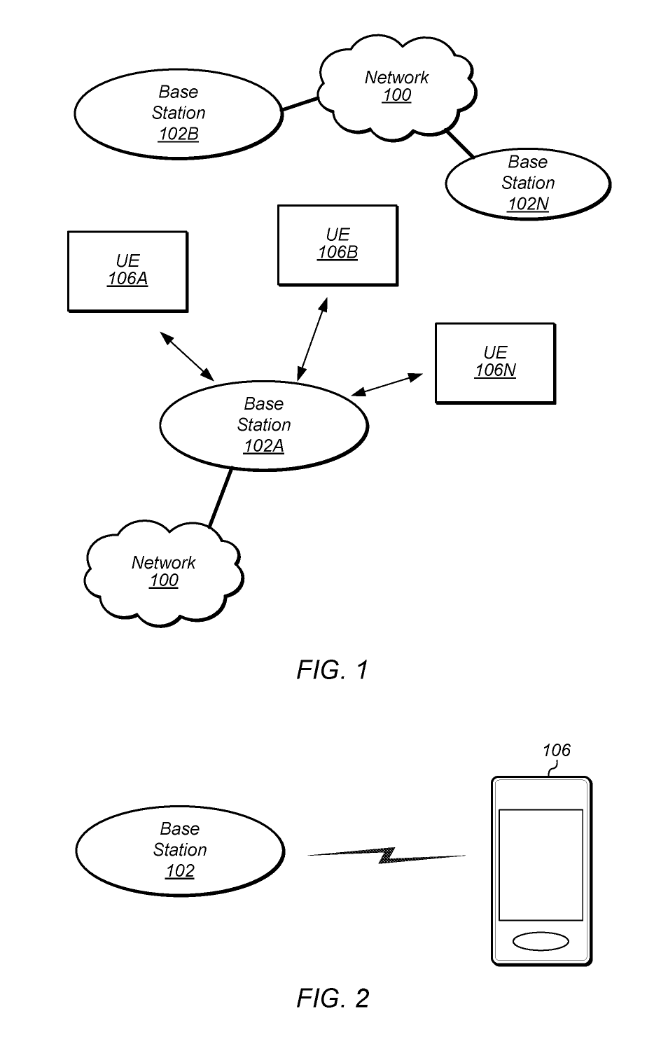

### FIGS. 1 and 2—Communication System

FIG. 1 illustrates an exemplary (and simplified) wireless communication system, according to some embodiments. It is noted that the system of FIG. 1 is merely one example of a possible system, and embodiments may be implemented in any of various systems, as desired.

As shown, the exemplary wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station 102A may be a base transceiver station (BTS) or cell site, and may include hardware that enables wireless communication with the UEs 106A-106N. The base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices (UEs) and/or between the UEs and the network 100.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (WCDMA, TD-SCDMA), LTE, LTE-Advanced (LTE-A), HSPA, 3GPP2 CDMA2000 (e.g., 1×RTT, 1×EV-DO, HRPD, eHRPD), Wi-Fi, WiMAX etc.

Base station 102A and other similar base stations (such as base stations 102B . . . 102N) operating according to the same or a different cellular communication standard may thus be provided as a network of cells, which may provide continuous or nearly continuous overlapping service to UEs 106A-160N and similar devices over a wide geographic area via one or more cellular communication standards.

Thus, while base station 102A may act as a “serving cell” for UEs 106A-160N as illustrated in FIG. 1, each UE 106 may also possibly come within communication range of, and be capable of receiving signals from, one or more other cells (which might be provided by base stations 102B-N and/or any other base stations), which may be referred to as “neighboring cells.” Such cells may also be capable of facilitating communication between user devices and/or between user devices and the network 100, according to the same wireless communication technology as base station 102A and/or any of various other possible wireless communication technologies. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

Note that a UE 106 may be capable of communicating using multiple wireless communication standards. For example, a UE 106 may be configured to communicate using a wireless networking (e.g., Wi-Fi) and/or peer-to-peer wireless communication protocol (e.g., BT, Wi-Fi peer-to-peer, etc.) in addition to at least one cellular communication protocol (e.g., GSM, UMTS (WCDMA, TD-SCDMA), LTE, LTE-A, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 2 illustrates user equipment 106 (e.g., one of the devices 106A-106N) in communication with a base station 102 (e.g., one of the base stations 102A-102N), according to some embodiments. The UE 106 may be a device with cellular communication capability such as a mobile phone, a hand-held device, a wearable device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein. Alternatively, or in addition, the UE 106 may include one or more integrated circuits configured to perform any of the method embodiments described herein.

The UE 106 may include one or more antennas for communicating using one or more wireless communication protocols or technologies. In some embodiments, the UE 106 is configured to communicate using either of CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate (and possibly multiple) transmit and/or receive chains (e.g., including separate RF and/or digital radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 1×RTT (or LTE or GSM), and separate radios for communicating using each of Wi-Fi and Bluetooth. Other configurations are also possible.

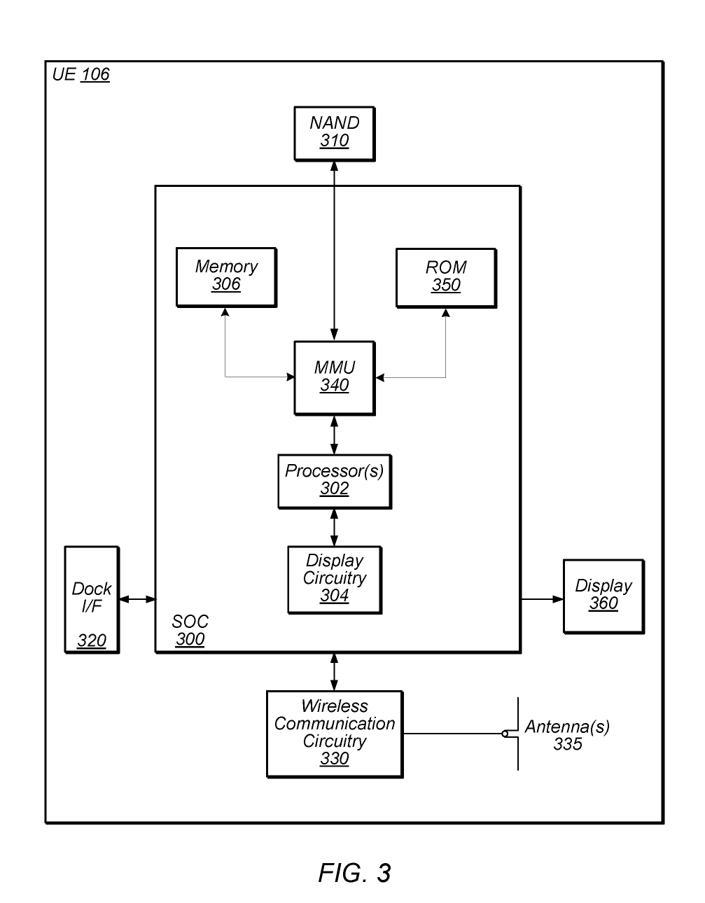

### FIG. 3—Exemplary Block Diagram of a UE

FIG. 3 illustrates an exemplary block diagram of a UE 106, according to some embodiments. As shown, the UE 106 may include a system on chip (SOC) 300, which may include processing elements for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, Wi-Fi, GPS, etc.).

The UE device 106 may include at least one antenna (and possibly multiple antennas, e.g., for MIMO and/or for implementing different wireless communication technologies, among various possibilities), for performing wireless communication with base stations and/or other devices. For example, the UE device 106 may use antenna(s) 335 to perform the wireless communication. As noted above, the UE 106 may be configured to communicate wirelessly using multiple wireless communication technologies in some embodiments.

As described further subsequently herein, the UE 106 may include hardware and software components for implementing features and methods described herein. The processor 302 of the UE device 106 may be configured to implement part or all of the methods described herein, e.g., by executing program instructions stored on a memory medium (e.g., a non-transitory computer-readable memory medium). In other embodiments, processor 302 may be configured as a programmable hardware element, such as an FPGA (Field Programmable Gate Array), or as an ASIC (Application Specific Integrated Circuit). Alternatively (or in addition), the processor 302 of the UE device 106, in conjunction with one or more of the other components 300, 304, 306, 310, 320, 330, 335, 340, 350, 360 may be configured to implement part or all of the features described herein.

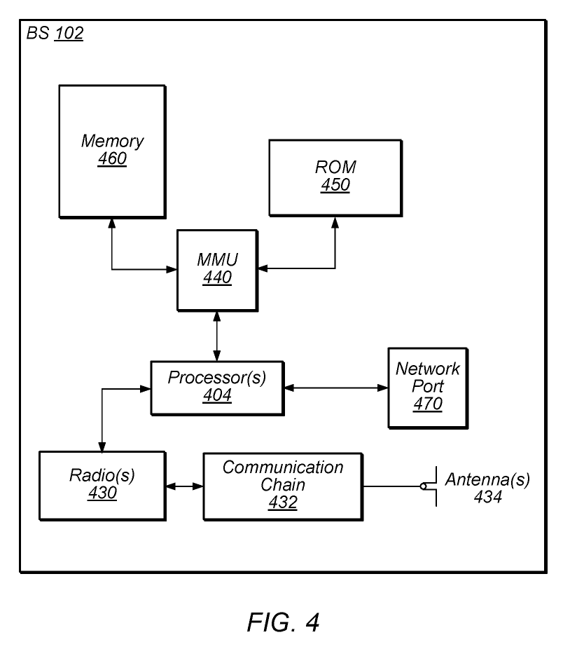

### FIG. 4—Exemplary Block Diagram of a Base Station

FIG. 4 illustrates an exemplary block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless telecommunication standards, including, but not limited to, LTE, LTE-A, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a Wi-Fi radio for performing communication according to Wi-Fi. In such a case, the base station 102 may be capable of operating as both an LTE base station and a Wi-Fi access point. As another possibility, the base station 102 may include a multi-mode radio which is capable of performing communications according to any of multiple wireless communication technologies (e.g., LTE and Wi-Fi).

The base station 102 may include hardware and software components for implementing or supporting implementation of features described herein. The processor 404 of the base station 102 may be configured to implement part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition), the processor 404 of the base station 102, in conjunction with one or more of the other components 430, 432, 434, 440, 450, 460, and/or 470, may be configured to implement or support implementation of part or all of the features described herein.

### Exemplary Techniques for UE-Side Early Handover Triggering

In some embodiments, UE 106 is configured to perform voice over internet protocol (VoIP) communications. VoIP utilizes packet-switched (PS) wireless network communications such as LTE rather than circuit-switched wireless network communications. VoIP calls, however, may be switched over to another network, e.g., when the PS network is unable to provide sufficient call quality. VoIP calls may include, without limitations: voice calls, video chat, etc. Voice over LTE (VoLTE) is one implementations of VoIP communication that guarantees a particular quality of service (QoS) and bit rate (GBR) for voice communications. Many interactive communications applications, however, do not utilize VoLTE. This may be the case for certain applications that always use a default bearer or for secondary devices, for example, that initiate a VoIP call over a Wi-Fi connection and then switch to a cellular connection. These applications may still have real-time communications requirements (e.g., if voice packets are lost, communications may be incoherent and video may have an insufficient framerate). Because these applications may operate on a wireless communications configuration that does not ensure that real-time constraints are met (e.g., a default bearer in LTE rather than a VoLTE bearer), the network may not provide a guaranteed quality of service to these applications.

One particular situation in which call quality may suffer is at the edge of an LTE cell. For example, if a VoIP call is being performed on LTE (a PS radio access technology (RAT)), call quality may suffer before communications are handed over to another RAT such as a CDMA RAT, for example. In some situations, an earlier handover to the other RAT would improve call quality, but the network is unaware that a handover is needed (e.g., because the call is not a VoLTE call). Further, other VoLTE techniques such as adjusting hybrid automatic repeat request (HARD) retransmissions may not be available for non-VoLTE bearers. Therefore, in some embodiments, UE 106 is configured to send a message to the network to initiate inter-RAT handover prior to a handover event specified by the network.

One example of an inter-RAT handover is associated with the B2 event in LTE. For reference, 3GPP TS 36.133, rel. 13 v. 13.3.0 sets out this event, among other events. The network provides thresholds for the current serving cell and a neighbor cell. In response to determining that these thresholds are met based on current wireless conditions, UE 106 is configured to send a measurement report to base station 102 to trigger a handover.

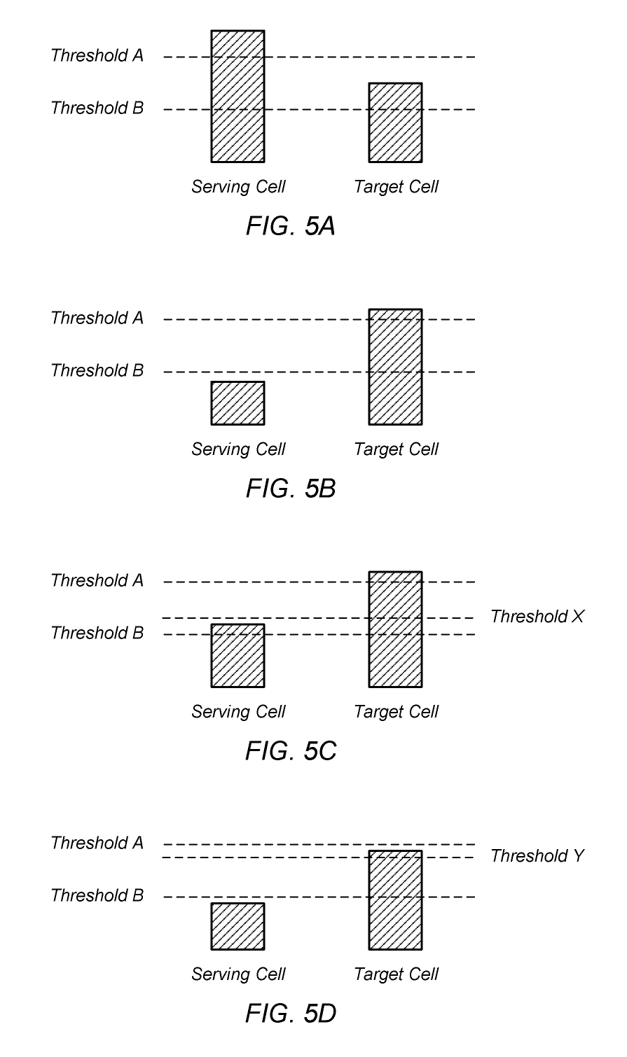

FIGS. 5A-5D show exemplary different wireless conditions for a serving cell and a target cell relative to various thresholds, according to some embodiments. In some embodiments, the serving cell and the target cell use different RATs. In some embodiments, the serving cell uses a PS RAT and the target cell uses a CS RAT.

In FIG. 5A, in the illustrated example, wireless conditions on the serving cell are above threshold B and wireless conditions on the target cell are below Threshold A. In some embodiments, the network specifies that UE 106 should send a measurement report to trigger a handover when the conditions on the serving cell are below threshold B and the conditions on the target cell are above threshold A. Therefore, in the situation of FIG. 5A, in these embodiments, UE 106 should not send a measurement report.

In contrast, in FIG. 5B, both thresholds are met (serving cell is below threshold B and target cell is above threshold A) and the network specifies that UE 106 should send a measurement report, upon detecting this situation, to trigger an inter-RAT handover. As discussed above, however, in some embodiments with VoIP calls on a default bearer, waiting until both thresholds are met may cause dropped calls or low call quality. Therefore, in some embodiments, UE 106 is configured to send a report to trigger a handover prior to both thresholds being met. FIGS. 5C and 5D show examples of such pre-emptive reporting.

FIG. 5C, for example, shows an internal UE threshold X. In some embodiments, in response to detecting that the target cell is above threshold A and that the serving cell is below threshold X, UE 106 is configured to send a message to the network (e.g., to a base station) to trigger handover, even though the serving cell has not deteriorated below the threshold B specified by the network. In some situations, this may allow the call to proceed on the target cell without dropping the call or losing call quality at the edge of the serving cell.

In some embodiments, UE 106 is not configured to use threshold X if it determines that there is another neighbor cell on the same RAT as the serving cell with good signal quality. In that case, the call can instead be handed over to the neighbor cell on the same RAT as opposed to switching RATs.

FIG. 5D illustrates an example in which another internal threshold (threshold Y) is implemented by UE 106. In some embodiments, UE 106 is configured to send a message to cause a handover in response to detecting that the serving cell is below threshold B and the target cell is above threshold Y, prior to the target cell reaching threshold A. In some embodiments, UE 106 implements both threshold X and threshold Y, and is configured to trigger a handover in response to determining that the serving cell is below threshold X and the target cell is above threshold Y.

The signal quality parameters indicated by the vertical bars in FIGS. 5A-5D may include, without limitation: reference signal received power (RSRP), reference signal received quality (RSRQ), signal to noise ratio (SNR), offset amount between parameters for different cells, combinations of parameters, etc.

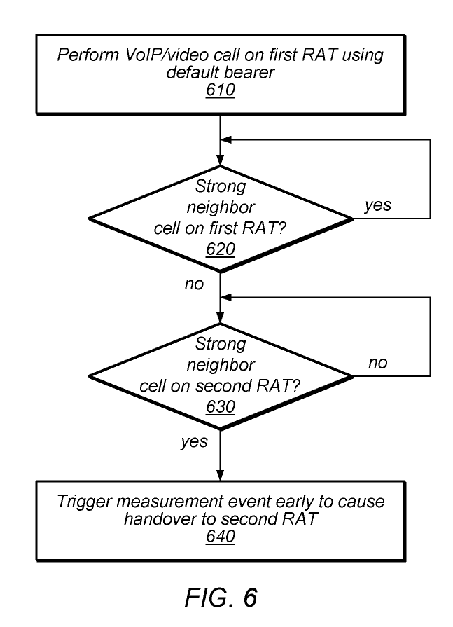

FIG. 6 is a block diagram illustrating an exemplary method performed by UE 106 to trigger inter-RAT handover, according to some embodiments. At 610, UE 106 performs, for example, a VoIP or video call on a first RAT (e.g., an LTE RAT) using a default bearer. In various embodiments, the default bearer does not provide a guaranteed QoS or bit rate. At 620, UE 106 determines whether there is a strong neighbor cell on the first RAT. If so, the method remains at 620 until a strong neighbor on the first RAT is not present (e.g., based on movement of UE 106 or changes in interference conditions). This may allow the network to handover to the strong neighbor cell if appropriate, avoiding any problems with call quality. If there is not a strong neighbor cell on the first RAT, the method proceeds to 630, where UE 106 determines whether there is a strong neighbor cell on a second RAT (e.g., a non-LTE RAT). If there is not a strong neighbor cell on the second RAT, the method remains at 630. This may cause the call to be eventually dropped or transferred to Wi-Fi for example, if strong neighbor cells for neither cellular RAT are available.

At 640, in the illustrated embodiment, if there is a strong neighbor cell on the second RAT at 630, UE 106 triggers a measurement event early to cause handover to the second RAT. In some embodiments, this is accomplished by sending a measurement report indicating the B2 LTE event (even though the thresholds for this event have not all been met). In other embodiments, any of various report formats may be used (including non-LTE formats), so long as the base station recognizes that the report should trigger a handover. In some embodiments, simply sending the report early causes an early handover. In other embodiments, e.g., in which the report contains measurement data, UE 106 is further configured to alter the reported measurement data (e.g., by adding or subtracting an offset value to a measured value) in order to trigger an early handover.

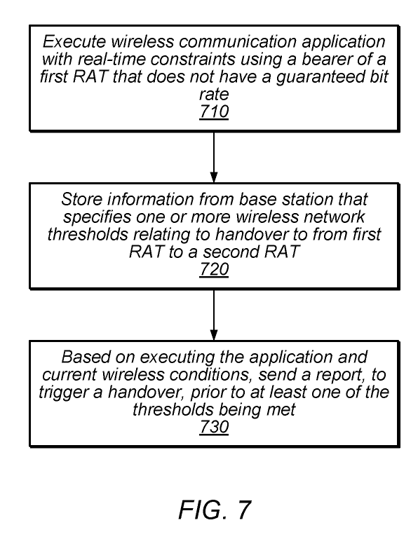

FIG. 7 is a flow diagram illustrating a more general method for triggering inter-RAT handover, according to some embodiments. The method shown in FIG. 8 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. Flow begins at 710.

At 710, in the illustrated embodiment, UE 106 executes a wireless communication application with real-time constraints using a bearer of a first RAT. The first RAT may be an LTE RAT, for example. In the illustrated embodiment, the bearer does not have a guaranteed bit rate. In some embodiments, the bearer is also not configured to provide a particular quality of service. In various embodiments, speaking generally, the bearer is not configured to ensure that the real-time constraints will be met. If the real-time constraints involve an interactive communications application such as a voice or video call, for example, this means that calls may suffer in quality or may be dropped when wireless conditions deteriorate, where another bearer (e.g., a VoLTE bearer) might have been able to use retransmissions, etc. to preserve quality. In some embodiments the bearer is an LTE default bearer.

At 720, in the illustrated embodiment, UE 106 stores information from the base station that specifies one or more wireless network thresholds relating to handover from the first RAT to a second RAT. For example, these thresholds may be for the LTE B2 event. In other embodiments, these thresholds may be for other events, including non-LTE events. These thresholds may or may not be specified by the base station for the current connection. For example, the thresholds may have been specified by the network and stored during a previous connection. In some embodiments, the thresholds are specified using a hysteresis value that is added to or subtracted from a known base threshold.

At 730, in the illustrated embodiment, UE 106 sends a report to trigger a handover to the second RAT. In the illustrated embodiment, UE 106 sends the report prior to at least one of the stored thresholds being met. In the illustrated embodiment, UE 106 sends the report based on executing the application and based on current wireless conditions. For example, in some embodiments UE 106 recognizes that the application has real-time constraints, determines current signal conditions on the first RAT, and triggers the handover to the second RAT before the signal conditions meet the stored thresholds.

In some embodiments, the disclosed methods of FIGS. 6 and 7 may cause the network to handover UE 106 to the second RAT earlier than specified by the network, when the second RAT has good signal conditions. FIGS. 5C and 5D, discussed above, illustrate exemplary situations where a handover is triggered earlier than specified by the network. This may preserve call quality at the edge of a cell of the first RAT, for example.

In various embodiments, the disclosed techniques may improve call quality and/or reduce dropped calls. Although the illustrated techniques are discussed with reference to inter-RAT handover, similar techniques may be used, in some embodiments, to trigger handover between cells of the same RAT prior to thresholds indicated by the network being met.

Embodiments of the present disclosure may be realized in any of various forms. For example some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, an apparatus comprises means for performing one or more of the method elements of one or more of FIGS. 6-7.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus, comprising:
one or more processing elements configured to:
execute an interactive wireless communication application using a wireless communication configuration between the apparatus and a communications network for a first radio access technology (RAT), wherein the wireless communication configuration does not have a quality of service (QoS) guarantee;
store information from the communications network that specifies one or more wireless thresholds relating to handover from the first RAT to a second RAT; and
based on executing the application and current wireless conditions, send a report to a base station of the communications network, prior to at least one of the thresholds being met, to trigger a handover from the first RAT to the second RAT.

2. The apparatus of claim 1, wherein the first RAT is an LTE RAT and the second RAT is another RAT.

3. The apparatus of claim 2, wherein the one or more wireless thresholds include a threshold for the first RAT and a threshold for the second RAT, wherein the thresholds correspond to an LTE B2 inter-RAT event.

4. The apparatus of claim 1, wherein the one or more processing elements are configured to send the report prior to a wireless measurement for a serving cell of the first RAT deteriorating below one of the one or more wireless thresholds.

5. The apparatus of claim 1, wherein the one or more processing elements are configured to send the report prior to a wireless measurement for a serving cell of the first RAT increasing above one of the one or more wireless thresholds.

6. The apparatus of claim 1, wherein the apparatus is a mobile device that further comprises at least one radio and at least one antenna coupled to the at least one radio for communication with the communications network.

7. The apparatus of claim 1, wherein the wireless communication configuration does not have a guaranteed bit rate.

8. The apparatus of claim 1, wherein the interactive wireless communication application is a voice over internet protocol (VoIP) application.

9. The apparatus of claim 1, wherein the interactive wireless communication application includes video.

10. A method, comprising:
executing a wireless communication application with real-time constraints using a bearer of a first radio access technology (RAT), wherein the bearer does not have a guaranteed bit rate;
storing information from a base station that specifies one or more wireless thresholds relating to handover from the first RAT to a second RAT; and
based on executing the application and current wireless conditions, sending a report to trigger a handover to the second RAT, wherein the sending is performed prior to at least one of the thresholds being met.

11. The method of claim 10, wherein the first RAT is an LTE RAT.

12. The method of claim 11, wherein the one or more wireless thresholds include a lower threshold for signal quality for the first RAT and an upper threshold for signal quality for the second RAT corresponding to an LTE B2 inter-RAT event.

13. The method of claim 12, wherein the sending is performed prior to at least one of: the signal quality for the first RAT deteriorating below the lower threshold or the signal quality for the second RAT improving above the upper threshold.

14. The method of claim 13, wherein the sending is performed prior to both the signal quality for the first RAT deteriorating below the lower threshold and the signal quality for the second RAT improving above the upper threshold.

15. The method of claim 10, wherein the wireless communication application is a voice over internet protocol (VoIP) application that does not utilize voice over LTE (VoLTE).

16. An apparatus, comprising:
one or more processing elements configured to:
execute a voice over internet protocol (VoIP) application using a default bearer of an LTE radio access technology (RAT), wherein the default bearer does not have a guaranteed quality of service;
store information from a base station that specifies one or more wireless thresholds relating to handover from the LTE RAT to another RAT; and
based on executing the VoIP application and in response to determining that wireless conditions are above a threshold for a cell of the other RAT, send a report, prior to wireless conditions on a cell of the LTE RAT deteriorating below a threshold specified by the stored information, to trigger a handover to the other RAT.

17. The apparatus of claim 16, VoIP application includes video.

18. The apparatus of claim 17, wherein the VoIP application does not utilize voice over LTE (VoLTE).

19. The apparatus of claim 16, wherein the one or more processing elements are further configured to send the report prior to wireless conditions on a neighbor cell of the other RAT improving above a threshold specified by the stored information.

20. The apparatus of claim 16, wherein the one or more processing elements are further configured to send the report based on a neighbor cell of the other RAT improving above a threshold specified by the stored information.
